(19) United States
(12) Patent Application Publication
(10) Pub. No.: US 2025/0008288 A1
(43) Pub. Date: Jan. 2, 2025

(54) A Method and Apparatus for AR Rendering Adaptation

(71) Applicant: Nokia Technologies Oy, Espoo (FI)

(72) Inventors: Sujeet Shyamsundar MATE, Tampere (FI); Jussi Artturi LEPPANEN, Tampere (FI); Antti Johannes ERONEN, Tampere (FI); Arto Juhani LEHTINIEMI, Lempaala (FI); Lasse Juhani LAAKSONEN, Tampere (FI)

(21) Appl. No.: 18/576,801

(22) PCT Filed: Jun. 22, 2022
(86) PCT No.: PCT/FI2022/050456

§ 371 Date: Jan. 5, 2024

(30) Foreign Application Priority Data
Jul. 14, 2021 (GB) 2110129.0

(51) Int. Cl. H04S 7/00

(52) U.S. Cl. CPC H04S 7/303

(57) ABSTRACT

An apparatus including circuitry configured to: obtain at least one audio signal; obtain at least one anchor parameter associated with the at least one audio signal; obtain information configured to assist in the adaptation of the at least one anchor parameter with at least one further anchor parameter within an audio scene within which the at least one audio signal is to be rendered.

### FIELD

The present application relates to method and apparatus for augmented reality rendering adaptation, but not exclusively for method and apparatus for augmented reality rendering adaptation for 6 degrees-of-freedom rendering.

### BACKGROUND

Augmented Reality (AR) applications (and other similar virtual scene creation applications such as Mixed Reality (MR) and Virtual Reality (VR)) where a virtual scene is represented to a user wearing a head mounted device (HMD) have become more complex and sophisticated over time. The application may comprise data which comprises a visual component (or overlay) and an audio component (or overlay) which is presented to the user. These components may be provided to the user dependent on the position and orientation of the user (for a 6 degree-of-freedom application) within an Augmented Reality (AR) scene.

Scene information for rendering an AR scene typically comprises two parts. One part is the virtual scene information which may be described during content creation (or by a suitable capture apparatus or device) and represents the scene as captured (or initially generated). The virtual scene may be provided in an encoder input format (EIF) data format. The EIF and (captured or generated) audio data is used by an encoder to generate the scene description and spatial audio metadata (and audio signals), which can be delivered via the bitstream to the rendering (playback) device or apparatus. The scene description for an AR or VR scene is thus specified by the content creator during a content creation phase. In the case of VR, the scene is specified in its entirety and it is rendered exactly as specified in the content creator bitstream.

The second part of the AR audio scene rendering is related to the physical listening space (or physical space) of the listener (or end user). The scene or listener space information may be obtained during the AR rendering (when the listener is consuming the content). Thus there is a fundamental aspect of AR which is different from VR, which means the acoustic properties of the audio scene are known (for AR) only during content consumption and cannot be known or optimized during content creation.

FIG. 1a shows an example AR scene where a virtual scene is located within a physical listening space. In this example there is a user 107 who is located within a physical listening space 101. Furthermore in this example the user 109 is experiencing a six-degree-of-freedom (6DOF) virtual scene 113 with virtual scene elements. In this example the virtual scene 113 elements are represented by two audio objects, a first object 103 (guitar player) and second object 105 (drummer), a virtual occlusion element (e.g., represented as a virtual partition 117) and a virtual room 115 (e.g., with walls which have a size, a position, acoustic materials which are defined within the virtual scene description). A renderer (which in this example is a hand held electronic device or apparatus 111) is configured to perform the rendering so that the auralization is plausible for the user's physical listening space (e.g., position of the walls and the acoustic material properties of the wall). The rendering is presented to the user 107 in this example by a suitable headphone or headset 109.

Thus for AR scenes, the content creator bitstream carries information about which audio elements and scene geometry elements correspond to which anchors in the listening space. Consequently, the positions of the audio element positions, reflecting elements, occluding elements, etc. are known only during rendering. Furthermore, the acoustic modeling parameters are known only during rendering.

The position of the audio elements and scene geometry elements is known during rendering time with the help of the “anchors” which are embedded within the listening space description of the listening space, which is obtained during content consumption. The expectation is that the anchors referred to in the content creator bitstream find a corresponding match in the listening space description. This description has been specified in the MPEG Audio group as LSDF (Listener Space Description Format) file as the means for providing listener space information to the renderer. The LSDF file is available only during rendering. Consequently, the derivation of acoustic scene information acoustic modelling parameters is done in the renderer in case of AR scenarios.

### SUMMARY

There is provided according to a first aspect an apparatus comprising means configured to: obtain at least one audio signal; obtain at least one anchor parameter associated with the at least one audio signal; obtain information configured to assist in the adaptation of the at least one anchor parameter with at least one further anchor parameter within an audio scene within which the at least one audio signal is to be rendered.

The information configured to assist in the adaptation may comprise guidance metadata configured to assist in the adaptation of the at least one anchor parameter with at least one further anchor parameter within an audio scene within which the at least one audio signal is to be rendered.

The information configured to assist in the adaptation may comprise information configured to define a geometry of a virtual or augmented audio scene and the at least one anchor parameter defines a position with respect to the virtual or augmented audio scene geometry.

The means configured to obtain information configured to assist in the adaptation may be configured to obtain at least one of: a spatial filtering parameter configured to control a mapping of at least one audio element anchor to at least one anchor within the audio scene within which the at least one audio signal is to be rendered based on a distance between the one audio element anchor and the at least one anchor within the audio scene; a temporal filtering parameter configured to control a mapping of at least one audio element anchor to at least one anchor within the audio scene within which the at least one audio signal is to be rendered based on a time difference between the one audio element anchor and the at least one anchor within the audio scene; and a priority list parameter configured to control a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal is to be rendered based on the distance between the one audio element anchor and the at least one anchor within the audio scene may be configured to control the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

Mapping of at least one audio element anchor to at least one anchor within the audio scene within which the at least one audio signal is to be rendered based on a time difference between the one audio element anchor and the at least one anchor within the audio scene may be configured to control a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

The means configured to obtain information configured to assist in the adaptation may be configured to obtain a processor filtering parameter configured to control a mapping of at least one audio element anchor to at least one anchor within the audio scene based on a renderer processor value.

The means configured to obtain information configured to assist in the adaptation may be configured to obtain at least one of: an alternative anchor filtering parameter configured to control a mapping of the at least one audio element anchor to an alternative one of at least one anchor within the audio scene where there is no matching label between the at least one audio element anchor and the at least one anchor within the audio scene; a default position parameter configured to control a positioning of the at least one audio element anchor within the audio scene where there is no matching label between the at least one audio element anchor and the at least one anchor within the audio scene; and a multiple anchors parameter comprising identifiers identifying at least two candidate anchors within the audio scene and configured to control a mapping to at least one of the candidate anchors within the audio scene based on at least one of the candidate anchors being located within the audio scene.

The means configured to obtain information configured to assist in the adaptation of the at least one anchor parameter with at least one further anchor parameter within an audio scene within which the at least one audio signal is to be rendered may be configured to obtain an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

The means configured to obtain information configured to assist in the adaptation of the at least one anchor parameter with at least one further anchor parameter within an audio scene within which the at least one audio signal is to be rendered may be configured to obtain a mapping modification processing parameter configured to control whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

The means configured to obtain information configured to assist in the adaptation of the at least one anchor parameter with at least one further anchor parameter within an audio scene within which the at least one audio signal is to be rendered may be configured to obtain a dynamic updating parameter configured to control whether the at least one audio element anchor can dynamically move within the audio scene.

The dynamic updating parameter is configured to control whether the at least one audio element anchor may dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to a second aspect there is provided an apparatus comprising means configured to: generate at least one bitstream, wherein the bitstream comprises: at least one audio signal; at least one anchor parameter associated with the at least one audio signal; and information configured to assist in the adaptation of the at least one audio scene anchor parameter with at least one further anchor parameter within an audio scene within which the at least one audio signal is to be rendered.

The information configured to assist in the adaptation may comprise guidance metadata configured to assist in the adaptation of the at least one anchor parameter with at least one further anchor parameter within an audio scene within which the at least one audio signal is to be rendered.

The information configured to assist in the adaptation may comprise information configured to define a geometry of a virtual or augmented audio scene and the at least one anchor parameter defines a position with respect to the virtual or augmented audio scene geometry.

The information configured to assist in the adaptation may be at least one of: a spatial filtering parameter configured to control a mapping of at least one audio element anchor to at least one anchor within the audio scene within which the at least one audio signal is to be rendered based on a distance between the one audio element anchor and the at least one anchor within the audio scene; a temporal filtering parameter configured to control a mapping of at least one audio element anchor to at least one anchor within the audio scene within which the at least one audio signal is to be rendered based on a time difference between the one audio element anchor and the at least one anchor within the audio scene; and a priority list parameter configured to control a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal may be rendered based on the distance between the one audio element anchor and the at least one anchor within the audio scene is configured to control the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

The spatial filtering parameter configured to control mapping of at least one audio element anchor to at least one anchor within the audio scene within which the at least one audio signal is to be rendered based on a time difference between the one audio element anchor and the at least one anchor within the audio scene may be the spatial filtering parameter configured to control a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

The information configured to assist in the adaptation is a processor filtering parameter may be configured to control a mapping of at least one audio element anchor to at least one anchor within the audio scene based on a renderer processor value.

The information configured to assist in the adaptation may be at least one of: an alternative anchor filtering parameter configured to control a mapping of the at least one audio element anchor to an alternative one of at least one anchor within the audio scene where there is no matching label between the at least one audio element anchor and the at least one anchor within the audio scene; a default position parameter configured to control a positioning of the at least one audio element anchor within the audio scene where there is no matching label between the at least one audio element anchor and the at least one anchor within the audio scene; and a multiple anchors parameter comprising identifiers identifying at least two candidate anchors within the audio scene and configured to control a mapping to at least one of the candidate anchors within the audio scene based on at least one of the candidate anchors being located within the audio scene.

The information configured to assist in the adaptation of the at least one anchor parameter with at least one further anchor parameter within an audio scene within which the at least one audio signal is to be rendered may be an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

The information configured to assist in the adaptation of the at least one anchor parameter with at least one further anchor parameter within an audio scene within which the at least one audio signal is to be rendered may be configured to control whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

The information configured to assist in the adaptation of the at least one anchor parameter with at least one further anchor parameter within an audio scene within which the at least one audio signal is to be rendered may be a dynamic updating parameter configured to control whether the at least one audio element anchor can dynamically move within the audio scene.

The dynamic updating parameter may be configured to control whether the at least one audio element anchor can dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to a third aspect there is provided an apparatus for rendering at least one audio signal within an audio scene, the apparatus comprising means configured to: determine, for the audio scene, at least one audio scene anchor parameter; obtain, from at least one further apparatus a bitstream, the bitstream comprising: the at least one audio signal; at least one anchor parameter associated with the at least one audio signal; and information configured to assist in the adaptation of the at least one anchor parameter with the at least one audio scene anchor parameter; associate the at least one anchor parameter with the at least one audio scene anchor parameter based on the information configured to assist in the adaptation of the at least one anchor parameter with the at least one audio scene anchor parameter; and render the at least one audio signal based on the association between the at least one anchor parameter with the at least one audio scene anchor parameter.

The information configured to assist in the adaptation may comprise guidance metadata configured to assist in the adaptation of the at least one anchor parameter with at least one further anchor parameter within an audio scene within which the at least one audio signal is to be rendered.

The at least one audio scene anchor parameter may be configured to define at least one of: a position within the audio scene; and a number of instances within the audio scene.

The information configured to assist in the adaptation comprises information configured to define a geometry of a virtual or augmented audio scene and the at least one anchor parameter may define a position with respect to the virtual or augmented audio scene geometry.

The information configured to assist in the adaptation may be at least one of: a spatial filtering parameter, wherein the means configured to associate the at least one anchor parameter with the at least one audio scene anchor parameter is configured to control a mapping of at least one audio element anchor to at least one anchor within the audio scene within which the at least one audio signal is to be rendered based on a distance between the one audio element anchor and the at least one anchor within the audio scene; a temporal filtering parameter wherein the means configured to associate the at least one anchor parameter with the at least one audio scene anchor parameter is configured to control a mapping of at least one audio element anchor to at least one anchor within the audio scene within which the at least one audio signal is to be rendered based on a time difference between the one audio element anchor and the at least one anchor within the audio scene; and a priority list parameter configured wherein the means configured to associate the at least one anchor parameter with the at least one audio scene anchor parameter is configured to control a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal is to be rendered based on the distance between the one audio element anchor and the at least one anchor within the audio scene may be configured to control the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

The apparatus configured to control the mapping of at least one audio element anchor to at least one anchor within the audio scene within which the at least one audio signal is to be rendered based on a time difference between the one audio element anchor and the at least one anchor within the audio scene may be configured to control a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

The information configured to assist in the adaptation may be a processor filtering parameter wherein the means configured to associate the at least one anchor parameter with the at least one audio scene anchor parameter is configured to control a mapping of at least one audio element anchor to at least one anchor within the audio scene based on a renderer processor value.

The information configured to assist in the adaptation may be at least one of: an alternative anchor filtering parameter wherein the means configured to associate the at least one anchor parameter with the at least one audio scene anchor parameter is configured to control a mapping of the at least one audio element anchor to an alternative one of at least one anchor within the audio scene where there is no matching label between the at least one audio element anchor and the at least one anchor within the audio scene; a default position parameter wherein the means configured to associate the at least one anchor parameter with the at least one audio scene anchor parameter is configured to control a positioning of the at least one audio element anchor within the audio scene where there is no matching label between the at least one audio element anchor and the at least one anchor within the audio scene; and a multiple anchors parameter comprising identifiers identifying at least two candidate anchors within the audio scene and wherein the means configured to associate the at least one anchor parameter with the at least one audio scene anchor parameter is configured to control a mapping to at least one of the candidate anchors within the audio scene based on at least one of the candidate anchors being located within the audio scene.

The information configured to assist in the adaptation of the at least one anchor parameter with at least one further anchor parameter within an audio scene within which the at least one audio signal is to be rendered wherein the means configured to associate the at least one anchor parameter with the at least one audio scene anchor parameter may be configured to obtain an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

The information configured to assist in the adaptation of the at least one anchor parameter with at least one further anchor parameter within an audio scene within which the at least one audio signal is to be rendered may be a mapping modification processing parameter wherein the means configured to associate the at least one anchor parameter with the at least one audio scene anchor parameter may be configured to control whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

The information configured to assist in the adaptation of the at least one anchor parameter with at least one further anchor parameter within an audio scene within which the at least one audio signal is to be rendered may be a dynamic updating parameter configured to control whether the at least one audio element anchor can dynamically move within the audio scene.

The dynamic updating parameter may be configured to control whether the at least one audio element anchor can dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to a fourth aspect there is provided a method comprising: obtaining at least one audio signal; obtaining at least one anchor parameter associated with the at least one audio signal; obtaining information configured to assist in the adaptation of the at least one anchor parameter with at least one further anchor parameter within an audio scene within which the at least one audio signal is to be rendered.

The information configured to assist in the adaptation may comprise guidance metadata configured to assist in the adaptation of the at least one anchor parameter with at least one further anchor parameter within an audio scene within which the at least one audio signal is to be rendered.

The information configured to assist in the adaptation may comprise information configured to define a geometry of a virtual or augmented audio scene and the at least one anchor parameter defines a position with respect to the virtual or augmented audio scene geometry.

Obtaining information configured to assist in the adaptation may comprise obtaining at least one of: a spatial filtering parameter configured to control a mapping of at least one audio element anchor to at least one anchor within the audio scene within which the at least one audio signal is to be rendered based on a distance between the one audio element anchor and the at least one anchor within the audio scene; a temporal filtering parameter configured to control a mapping of at least one audio element anchor to at least one anchor within the audio scene within which the at least one audio signal is to be rendered based on a time difference between the one audio element anchor and the at least one anchor within the audio scene; and a priority list parameter configured to control a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal is to be rendered based on the distance between the one audio element anchor and the at least one anchor within the audio scene may be configured to control the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

Mapping of at least one audio element anchor to at least one anchor within the audio scene within which the at least one audio signal is to be rendered based on a time difference between the one audio element anchor and the at least one anchor within the audio scene may be configured to control a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

Obtaining information configured to assist in the adaptation may comprise obtaining a processor filtering parameter configured to control a mapping of at least one audio element anchor to at least one anchor within the audio scene based on a renderer processor value.

Obtaining information configured to assist in the adaptation may comprise obtaining at least one of: an alternative anchor filtering parameter configured to control a mapping of the at least one audio element anchor to an alternative one of at least one anchor within the audio scene where there is no matching label between the at least one audio element anchor and the at least one anchor within the audio scene; a default position parameter configured to control a positioning of the at least one audio element anchor within the audio scene where there is no matching label between the at least one audio element anchor and the at least one anchor within the audio scene; and a multiple anchors parameter comprising identifiers identifying at least two candidate anchors within the audio scene and configured to control a mapping to at least one of the candidate anchors within the audio scene based on at least one of the candidate anchors being located within the audio scene.

Obtaining information configured to assist in the adaptation of the at least one anchor parameter with at least one further anchor parameter within an audio scene within which the at least one audio signal is to be rendered may comprise obtaining an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

Obtaining information configured to assist in the adaptation of the at least one anchor parameter with at least one further anchor parameter within an audio scene within which the at least one audio signal is to be rendered may comprise obtaining a mapping modification processing parameter configured to control whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

Obtaining information configured to assist in the adaptation of the at least one anchor parameter with at least one further anchor parameter within an audio scene within which the at least one audio signal is to be rendered may comprise obtaining a dynamic updating parameter configured to control whether the at least one audio element anchor can dynamically move within the audio scene.

The dynamic updating parameter is configured to control whether the at least one audio element anchor may dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to a fifth aspect there is provided a method comprising: generating at least one bitstream, wherein the bitstream comprises: at least one audio signal; at least one anchor parameter associated with the at least one audio signal; and information configured to assist in the adaptation of the at least one audio scene anchor parameter with at least one further anchor parameter within an audio scene within which the at least one audio signal is to be rendered.

The information configured to assist in the adaptation may comprise guidance metadata configured to assist in the adaptation of the at least one anchor parameter with at least one further anchor parameter within an audio scene within which the at least one audio signal is to be rendered.

The information configured to assist in the adaptation may comprise information configured to define a geometry of a virtual or augmented audio scene and the at least one anchor parameter defines a position with respect to the virtual or augmented audio scene geometry.

The information configured to assist in the adaptation may be at least one of: a spatial filtering parameter configured to control a mapping of at least one audio element anchor to at least one anchor within the audio scene within which the at least one audio signal is to be rendered based on a distance between the one audio element anchor and the at least one anchor within the audio scene; a temporal filtering parameter configured to control a mapping of at least one audio element anchor to at least one anchor within the audio scene within which the at least one audio signal is to be rendered based on a time difference between the one audio element anchor and the at least one anchor within the audio scene; and a priority list parameter configured to control a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal may be rendered based on the distance between the one audio element anchor and the at least one anchor within the audio scene is configured to control the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

The spatial filtering parameter configured to control mapping of at least one audio element anchor to at least one anchor within the audio scene within which the at least one audio signal is to be rendered based on a time difference between the one audio element anchor and the at least one anchor within the audio scene may be the spatial filtering parameter configured to control a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

The information configured to assist in the adaptation is a processor filtering parameter may be configured to control a mapping of at least one audio element anchor to at least one anchor within the audio scene based on a renderer processor value.

The information configured to assist in the adaptation may be at least one of: an alternative anchor filtering parameter configured to control a mapping of the at least one audio element anchor to an alternative one of at least one anchor within the audio scene where there is no matching label between the at least one audio element anchor and the at least one anchor within the audio scene; a default position parameter configured to control a positioning of the at least one audio element anchor within the audio scene where there is no matching label between the at least one audio element anchor and the at least one anchor within the audio scene; and a multiple anchors parameter comprising identifiers identifying at least two candidate anchors within the audio scene and configured to control a mapping to at least one of the candidate anchors within the audio scene based on at least one of the candidate anchors being located within the audio scene.

The information configured to assist in the adaptation of the at least one anchor parameter with at least one further anchor parameter within an audio scene within which the at least one audio signal is to be rendered may be an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

The information configured to assist in the adaptation of the at least one anchor parameter with at least one further anchor parameter within an audio scene within which the at least one audio signal is to be rendered may be configured to control whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

The information configured to assist in the adaptation of the at least one anchor parameter with at least one further anchor parameter within an audio scene within which the at least one audio signal is to be rendered may be a dynamic updating parameter configured to control whether the at least one audio element anchor can dynamically move within the audio scene.

The dynamic updating parameter may be configured to control whether the at least one audio element anchor can dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to a sixth aspect there is provided a method for rendering at least one audio signal within an audio scene, the method comprising: determining, for the audio scene, at least one audio scene anchor parameter; obtaining, from at least one further apparatus a bitstream, the bitstream comprising: the at least one audio signal; at least one anchor parameter associated with the at least one audio signal; and information configured to assist in the adaptation of the at least one anchor parameter with the at least one audio scene anchor parameter; associating the at least one anchor parameter with the at least one audio scene anchor parameter based on the information configured to assist in the adaptation of the at least one anchor parameter with the at least one audio scene anchor parameter; and rendering the at least one audio signal based on the association between the at least one anchor parameter with the at least one audio scene anchor parameter.

The information configured to assist in the adaptation may comprise guidance metadata configured to assist in the adaptation of the at least one anchor parameter with at least one further anchor parameter within an audio scene within which the at least one audio signal is to be rendered.

The at least one audio scene anchor parameter may be configured to define at least one of: a position within the audio scene; and a number of instances within the audio scene.

The information configured to assist in the adaptation comprises information configured to define a geometry of a virtual or augmented audio scene and the at least one anchor parameter may define a position with respect to the virtual or augmented audio scene geometry.

The information configured to assist in the adaptation may be at least one of: a spatial filtering parameter, wherein associating the at least one anchor parameter with the at least one audio scene anchor parameter may comprise controlling a mapping of at least one audio element anchor to at least one anchor within the audio scene within which the at least one audio signal is to be rendered based on a distance between the one audio element anchor and the at least one anchor within the audio scene; a temporal filtering parameter wherein associating the at least one anchor parameter with the at least one audio scene anchor parameter may comprise controlling a mapping of at least one audio element anchor to at least one anchor within the audio scene within which the at least one audio signal is to be rendered based on a time difference between the one audio element anchor and the at least one anchor within the audio scene; and a priority list parameter configured wherein associating the at least one anchor parameter with the at least one audio scene anchor parameter may comprise controlling a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal is to be rendered based on the distance between the one audio element anchor and the at least one anchor within the audio scene may comprise controlling the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

Controlling the mapping of at least one audio element anchor to at least one anchor within the audio scene within which the at least one audio signal is to be rendered based on a time difference between the one audio element anchor and the at least one anchor within the audio scene may comprise controlling a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

The information configured to assist in the adaptation may be a processor filtering parameter wherein associating the at least one anchor parameter with the at least one audio scene anchor parameter may comprise control a mapping of at least one audio element anchor to at least one anchor within the audio scene based on a renderer processor value.

The information configured to assist in the adaptation may be at least one of: an alternative anchor filtering parameter wherein associating the at least one anchor parameter with the at least one audio scene anchor parameter may comprise controlling a mapping of the at least one audio element anchor to an alternative one of at least one anchor within the audio scene where there is no matching label between the at least one audio element anchor and the at least one anchor within the audio scene; a default position parameter wherein associating the at least one anchor parameter with the at least one audio scene anchor parameter may comprise controlling a positioning of the at least one audio element anchor within the audio scene where there is no matching label between the at least one audio element anchor and the at least one anchor within the audio scene; and a multiple anchors parameter may comprise identifiers identifying at least two candidate anchors within the audio scene and wherein associating the at least one anchor parameter with the at least one audio scene anchor parameter may comprise controlling a mapping to at least one of the candidate anchors within the audio scene based on at least one of the candidate anchors being located within the audio scene.

The information configured to assist in the adaptation of the at least one anchor parameter with at least one further anchor parameter within an audio scene within which the at least one audio signal is to be rendered wherein associating the at least one anchor parameter with the at least one audio scene anchor parameter may comprise obtaining an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

The information configured to assist in the adaptation of the at least one anchor parameter with at least one further anchor parameter within an audio scene within which the at least one audio signal is to be rendered may be a mapping modification processing parameter wherein associating the at least one anchor parameter with the at least one audio scene anchor parameter may comprise controlling whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

The information configured to assist in the adaptation of the at least one anchor parameter with at least one further anchor parameter within an audio scene within which the at least one audio signal is to be rendered may be a dynamic updating parameter configured to control whether the at least one audio element anchor can dynamically move within the audio scene.

The dynamic updating parameter may be configured to control whether the at least one audio element anchor can dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to a seventh aspect there is provided an apparatus comprising at least one processor and at least one memory including a computer program code, the at least one memory and the computer program code configured to, with the at least one processor, cause the apparatus at least to: obtain at least one audio signal; obtain at least one anchor parameter associated with the at least one audio signal; obtain information configured to assist in the adaptation of the at least one anchor parameter with at least one further anchor parameter within an audio scene within which the at least one audio signal is to be rendered.

The information configured to assist in the adaptation may comprise guidance metadata configured to assist in the adaptation of the at least one anchor parameter with at least one further anchor parameter within an audio scene within which the at least one audio signal is to be rendered.

The information configured to assist in the adaptation may comprise information configured to define a geometry of a virtual or augmented audio scene and the at least one anchor parameter defines a position with respect to the virtual or augmented audio scene geometry.

The apparatus caused to obtain information configured to assist in the adaptation may be caused to obtain at least one of: a spatial filtering parameter configured to control a mapping of at least one audio element anchor to at least one anchor within the audio scene within which the at least one audio signal is to be rendered based on a distance between the one audio element anchor and the at least one anchor within the audio scene; a temporal filtering parameter configured to control a mapping of at least one audio element anchor to at least one anchor within the audio scene within which the at least one audio signal is to be rendered based on a time difference between the one audio element anchor and the at least one anchor within the audio scene; and a priority list parameter configured to control a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal is to be rendered based on the distance between the one audio element anchor and the at least one anchor within the audio scene may be configured to control the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

The apparatus caused to control a map at least one audio element anchor to at least one anchor within the audio scene within which the at least one audio signal is to be rendered based on a time difference between the one audio element anchor and the at least one anchor within the audio scene may be caused to control a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

The apparatus caused to obtain information configured to assist in the adaptation may be caused to obtain a processor filtering parameter configured to control a mapping of at least one audio element anchor to at least one anchor within the audio scene based on a renderer processor value.

The apparatus caused to obtain information configured to assist in the adaptation may be caused to obtain at least one of: an alternative anchor filtering parameter configured to control a mapping of the at least one audio element anchor to an alternative one of at least one anchor within the audio scene where there is no matching label between the at least one audio element anchor and the at least one anchor within the audio scene; a default position parameter configured to control a positioning of the at least one audio element anchor within the audio scene where there is no matching label between the at least one audio element anchor and the at least one anchor within the audio scene; and a multiple anchors parameter comprising identifiers identifying at least two candidate anchors within the audio scene and configured to control a mapping to at least one of the candidate anchors within the audio scene based on at least one of the candidate anchors being located within the audio scene.

The apparatus caused to obtain information configured to assist in the adaptation of the at least one anchor parameter with at least one further anchor parameter within an audio scene within which the at least one audio signal is to be rendered may be caused to obtain an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

The apparatus caused to obtain information configured to assist in the adaptation of the at least one anchor parameter with at least one further anchor parameter within an audio scene within which the at least one audio signal is to be rendered may be caused to obtain a mapping modification processing parameter configured to control whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

The apparatus caused to obtain information configured to assist in the adaptation of the at least one anchor parameter with at least one further anchor parameter within an audio scene within which the at least one audio signal is to be rendered may be caused to obtain a dynamic updating parameter configured to control whether the at least one audio element anchor can dynamically move within the audio scene.

The dynamic updating parameter may be configured to control whether the at least one audio element anchor may dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to an eighth aspect there is provided an apparatus comprising at least one processor and at least one memory including a computer program code, the at least one memory and the computer program code configured to, with the at least one processor, cause the apparatus at least to: generate at least one bitstream, wherein the bitstream comprises: at least one audio signal; at least one anchor parameter associated with the at least one audio signal; and information configured to assist in the adaptation of the at least one audio scene anchor parameter with at least one further anchor parameter within an audio scene within which the at least one audio signal is to be rendered.

The information configured to assist in the adaptation may comprise guidance metadata configured to assist in the adaptation of the at least one anchor parameter with at least one further anchor parameter within an audio scene within which the at least one audio signal is to be rendered.

The information configured to assist in the adaptation may comprise information configured to define a geometry of a virtual or augmented audio scene and the at least one anchor parameter defines a position with respect to the virtual or augmented audio scene geometry.

The information configured to assist in the adaptation may be at least one of: a spatial filtering parameter configured to control a mapping of at least one audio element anchor to at least one anchor within the audio scene within which the at least one audio signal is to be rendered based on a distance between the one audio element anchor and the at least one anchor within the audio scene; a temporal filtering parameter configured to control a mapping of at least one audio element anchor to at least one anchor within the audio scene within which the at least one audio signal is to be rendered based on a time difference between the one audio element anchor and the at least one anchor within the audio scene; and a priority list parameter configured to control a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal may be rendered based on the distance between the one audio element anchor and the at least one anchor within the audio scene is configured to control the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

The spatial filtering parameter configured to control mapping of at least one audio element anchor to at least one anchor within the audio scene within which the at least one audio signal is to be rendered based on a time difference between the one audio element anchor and the at least one anchor within the audio scene may be the spatial filtering parameter configured to control a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

The information configured to assist in the adaptation is a processor filtering parameter may be configured to control a mapping of at least one audio element anchor to at least one anchor within the audio scene based on a renderer processor value.

The information configured to assist in the adaptation may be at least one of: an alternative anchor filtering parameter configured to control a mapping of the at least one audio element anchor to an alternative one of at least one anchor within the audio scene where there is no matching label between the at least one audio element anchor and the at least one anchor within the audio scene; a default position parameter configured to control a positioning of the at least one audio element anchor within the audio scene where there is no matching label between the at least one audio element anchor and the at least one anchor within the audio scene; and a multiple anchors parameter comprising identifiers identifying at least two candidate anchors within the audio scene and configured to control a mapping to at least one of the candidate anchors within the audio scene based on at least one of the candidate anchors being located within the audio scene.

The information configured to assist in the adaptation of the at least one anchor parameter with at least one further anchor parameter within an audio scene within which the at least one audio signal is to be rendered may be an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

The information configured to assist in the adaptation of the at least one anchor parameter with at least one further anchor parameter within an audio scene within which the at least one audio signal is to be rendered may be configured to control whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

The information configured to assist in the adaptation of the at least one anchor parameter with at least one further anchor parameter within an audio scene within which the at least one audio signal is to be rendered may be a dynamic updating parameter configured to control whether the at least one audio element anchor can dynamically move within the audio scene.

The dynamic updating parameter may be configured to control whether the at least one audio element anchor can dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to a ninth aspect there is provided an apparatus comprising at least one processor and at least one memory including a computer program code, the at least one memory and the computer program code configured to, with the at least one processor, cause the apparatus at least to: determine, for the audio scene, at least one audio scene anchor parameter; obtain, from at least one further apparatus a bitstream, the bitstream comprising: the at least one audio signal; at least one anchor parameter associated with the at least one audio signal; and information configured to assist in the adaptation of the at least one anchor parameter with the at least one audio scene anchor parameter; associate the at least one anchor parameter with the at least one audio scene anchor parameter based on the information configured to assist in the adaptation of the at least one anchor parameter with the at least one audio scene anchor parameter; and render the at least one audio signal based on the association between the at least one anchor parameter with the at least one audio scene anchor parameter.

The information configured to assist in the adaptation may comprise guidance metadata configured to assist in the adaptation of the at least one anchor parameter with at least one further anchor parameter within an audio scene within which the at least one audio signal is to be rendered.

The at least one audio scene anchor parameter may be configured to define at least one of: a position within the audio scene; and a number of instances within the audio scene.

The information configured to assist in the adaptation comprises information configured to define a geometry of a virtual or augmented audio scene and the at least one anchor parameter may define a position with respect to the virtual or augmented audio scene geometry.

The information configured to assist in the adaptation may be at least one of: a spatial filtering parameter, wherein the apparatus caused to associate the at least one anchor parameter with the at least one audio scene anchor parameter may cause the apparatus to control a mapping of at least one audio element anchor to at least one anchor within the audio scene within which the at least one audio signal is to be rendered based on a distance between the one audio element anchor and the at least one anchor within the audio scene; a temporal filtering parameter wherein the apparatus caused to associate the at least one anchor parameter with the at least one audio scene anchor parameter may be caused to control a mapping of at least one audio element anchor to at least one anchor within the audio scene within which the at least one audio signal is to be rendered based on a time difference between the one audio element anchor and the at least one anchor within the audio scene; and a priority list parameter configured wherein the apparatus caused to associate the at least one anchor parameter with the at least one audio scene anchor parameter may be caused to control a mapping of at least one audio element anchor to at least one anchor within the audio scene within which the at least one audio signal is to be rendered based on a priority list of candidate mappings.

The spatial filtering parameter configured to control a mapping of at least one audio element anchor to at least one anchor within the audio scene within which the at least one audio signal is to be rendered based on the distance between the one audio element anchor and the at least one anchor within the audio scene may be configured to control the mapping based on one of: a nearest anchor selection for selecting at least one anchor within the audio scene nearest the at least one audio element anchor; a farthest anchor selection for selecting at least one anchor within the audio scene farthest from the at least one audio element anchor; a maximal spread anchor selection for selecting at least one anchor within the audio scene to distribute the at least one audio element anchor such that they are located with a largest spread with respect to each other; and a user input based anchor selection.

The apparatus configured to control the mapping of at least one audio element anchor to at least one anchor within the audio scene within which the at least one audio signal is to be rendered based on a time difference between the one audio element anchor and the at least one anchor within the audio scene may be configured to control a mapping based on one of: an earliest anchor selection for selecting an earliest of the at least one anchor within the audio scene; an earliest anchor selection for selecting an earliest of the at least one anchor within the audio scene with later modifications based on a user movement; a maximal spread anchor selection for selecting the at least one anchor within the audio scene to distribute the one audio element anchors farthest from each other; and a user input based anchor selection.

The information configured to assist in the adaptation may be a processor filtering parameter wherein the apparatus caused to associate the at least one anchor parameter with the at least one audio scene anchor parameter may be caused to control a mapping of at least one audio element anchor to at least one anchor within the audio scene based on a renderer processor value.

The information configured to assist in the adaptation may be at least one of: an alternative anchor filtering parameter wherein the apparatus caused to associate the at least one anchor parameter with the at least one audio scene anchor parameter may be caused to control a mapping of the at least one audio element anchor to an alternative one of at least one anchor within the audio scene where there is no matching label between the at least one audio element anchor and the at least one anchor within the audio scene; a default position parameter wherein the apparatus caused to associate the at least one anchor parameter with the at least one audio scene anchor parameter is caused to control a positioning of the at least one audio element anchor within the audio scene where there is no matching label between the at least one audio element anchor and the at least one anchor within the audio scene; and a multiple anchors parameter comprising identifiers identifying at least two candidate anchors within the audio scene and wherein the apparatus caused to associate the at least one anchor parameter with the at least one audio scene anchor parameter may be caused to control a mapping to at least one of the candidate anchors within the audio scene based on at least one of the candidate anchors being located within the audio scene.

The information configured to assist in the adaptation of the at least one anchor parameter with at least one further anchor parameter within an audio scene within which the at least one audio signal is to be rendered wherein the apparatus caused to associate the at least one anchor parameter with the at least one audio scene anchor parameter may be caused to obtain an instance processing parameter configured to control a processing of instances of a mapping of the at least one audio element anchor to at least one of the at least one anchor within the audio scene.

The instance processing parameter may be configured to control processing for one of: all instances of the mapping undergo full auralization processing; only the nearest mapping instance undergoes full auralization processing and the other instances are candidates for cluster processing; and only one mapping instance undergoes extent processing.

The information configured to assist in the adaptation of the at least one anchor parameter with at least one further anchor parameter within an audio scene within which the at least one audio signal is to be rendered may be a mapping modification processing parameter wherein the means configured to associate the at least one anchor parameter with the at least one audio scene anchor parameter may be configured to control whether a mapping modification or processing of instances of a mapping of the at least one audio element anchor to at least one of the at least one anchor within the audio scene.

The mapping modification processing parameter may be configured to control processing for one of: a change in a number of instances of the mapping is not allowed; a change in a number of instances of the mapping is allowed; an auralization change for elements associated with the instances of the mapping is not allowed; and an auralization change for elements associated with the instances of the mapping is allowed.

The information configured to assist in the adaptation of the at least one anchor parameter with at least one further anchor parameter within an audio scene within which the at least one audio signal is to be rendered may be a dynamic updating parameter configured to control whether the at least one audio element anchor can dynamically move within the audio scene.

The dynamic updating parameter may be configured to control whether the at least one audio element anchor can dynamically move within the audio scene for one of: infrequent updates with immediate response expected; frequent updates expected and where no filtering is to be applied; a renderer side filtering without look ahead prediction is to be implemented; and a S-curve filtering is to be implemented.

According to a tenth aspect there is provided an apparatus comprising: means for obtaining at least one audio signal; means for obtaining at least one anchor parameter associated with the at least one audio signal; means for obtaining information configured to assist in the adaptation of the at least one anchor parameter with at least one further anchor parameter within an audio scene within which the at least one audio signal is to be rendered.

According to an eleventh aspect there is provided an apparatus comprising: means for generating at least one bitstream, wherein the bitstream comprises: at least one audio signal; at least one anchor parameter associated with the at least one audio signal; and information configured to assist in the adaptation of the at least one audio scene anchor parameter with at least one further anchor parameter within an audio scene within which the at least one audio signal is to be rendered.

According to a twelfth aspect there is provided an apparatus comprising: means for determining, for the audio scene, at least one audio scene anchor parameter; means for obtaining, from at least one further apparatus a bitstream, the bitstream comprising: the at least one audio signal; at least one anchor parameter associated with the at least one audio signal; and information configured to assist in the adaptation of the at least one anchor parameter with the at least one audio scene anchor parameter; means for associating the at least one anchor parameter with the at least one audio scene anchor parameter based on the information configured to assist in the adaptation of the at least one anchor parameter with the at least one audio scene anchor parameter; and means for rendering the at least one audio signal based on the association between the at least one anchor parameter with the at least one audio scene anchor parameter.

According to a thirteenth aspect there is provided a computer program comprising instructions [or a computer readable medium comprising program instructions] for causing an apparatus to perform at least the following: obtain at least one audio signal; obtain at least one anchor parameter associated with the at least one audio signal; obtain information configured to assist in the adaptation of the at least one anchor parameter with at least one further anchor parameter within an audio scene within which the at least one audio signal is to be rendered.

According to a fourteenth aspect there is provided a computer program comprising instructions [or a computer readable medium comprising program instructions] for causing an apparatus to perform at least the following: generate at least one bitstream, wherein the bitstream comprises: at least one audio signal; at least one anchor parameter associated with the at least one audio signal; and information configured to assist in the adaptation of the at least one audio scene anchor parameter with at least one further anchor parameter within an audio scene within which the at least one audio signal is to be rendered.

According to a fifteenth aspect there is provided a computer program comprising instructions [or a computer readable medium comprising program instructions] for causing an apparatus to perform at least the following: determine, for the audio scene, at least one audio scene anchor parameter; obtain, from at least one further apparatus a bitstream, the bitstream comprising: the at least one audio signal; at least one anchor parameter associated with the at least one audio signal; and information configured to assist in the adaptation of the at least one anchor parameter with the at least one audio scene anchor parameter; associate the at least one anchor parameter with the at least one audio scene anchor parameter based on the information configured to assist in the adaptation of the at least one anchor parameter with the at least one audio scene anchor parameter; and render the at least one audio signal based on the association between the at least one anchor parameter with the at least one audio scene anchor parameter.

According to a sixteenth aspect there is provided a non-transitory computer readable medium comprising program instructions for causing an apparatus to perform at least the following: obtain at least one audio signal; obtain at least one anchor parameter associated with the at least one audio signal; obtain information configured to assist in the adaptation of the at least one anchor parameter with at least one further anchor parameter within an audio scene within which the at least one audio signal is to be rendered.

According to a seventeenth aspect there is provided a non-transitory computer readable medium comprising program instructions for causing an apparatus to perform at least the following: generate at least one bitstream, wherein the bitstream comprises: at least one audio signal; at least one anchor parameter associated with the at least one audio signal; and information configured to assist in the adaptation of the at least one audio scene anchor parameter with at least one further anchor parameter within an audio scene within which the at least one audio signal is to be rendered.

According to an eighteenth aspect there is provided a non-transitory computer readable medium comprising program instructions for causing an apparatus to perform at least the following: determine, for the audio scene, at least one audio scene anchor parameter; obtain, from at least one further apparatus a bitstream, the bitstream comprising: the at least one audio signal; at least one anchor parameter associated with the at least one audio signal; and information configured to assist in the adaptation of the at least one anchor parameter with the at least one audio scene anchor parameter; associate the at least one anchor parameter with the at least one audio scene anchor parameter based on the information configured to assist in the adaptation of the at least one anchor parameter with the at least one audio scene anchor parameter; and render the at least one audio signal based on the association between the at least one anchor parameter with the at least one audio scene anchor parameter.

According to a nineteenth aspect there is provided an apparatus comprising: obtaining circuitry configured to obtain at least one audio signal; obtaining circuitry configured to obtain at least one anchor parameter associated with the at least one audio signal; obtaining circuitry configured to obtain information configured to assist in the adaptation of the at least one anchor parameter with at least one further anchor parameter within an audio scene within which the at least one audio signal is to be rendered.

According to a twentieth aspect there is provided an apparatus comprising: generating circuitry configured to obtain generate at least one bitstream, wherein the bitstream comprises: at least one audio signal; at least one anchor parameter associated with the at least one audio signal; and information configured to assist in the adaptation of the at least one audio scene anchor parameter with at least one further anchor parameter within an audio scene within which the at least one audio signal is to be rendered.

According to a twenty-first aspect there is provided an apparatus comprising: determining circuitry configured to determine, for the audio scene, at least one audio scene anchor parameter; obtain, from at least one further apparatus a bitstream, the bitstream comprising: the at least one audio signal; at least one anchor parameter associated with the at least one audio signal; and information configured to assist in the adaptation of the at least one anchor parameter with the at least one audio scene anchor parameter; associating circuitry configured to associate the at least one anchor parameter with the at least one audio scene anchor parameter based on the information configured to assist in the adaptation of the at least one anchor parameter with the at least one audio scene anchor parameter; and rendering circuitry configured to render the at least one audio signal based on the association between the at least one anchor parameter with the at least one audio scene anchor parameter.

According to a twenty-second aspect there is provided a computer readable medium comprising program instructions for causing an apparatus to perform at least the following: obtain at least one audio signal; obtaining circuitry configured to obtain at least one anchor parameter associated with the at least one audio signal; obtaining circuitry configured to obtain information configured to assist in the adaptation of the at least one anchor parameter with at least one further anchor parameter within an audio scene within which the at least one audio signal is to be rendered.

According to a twenty-third aspect there is provided a computer readable medium comprising program instructions for causing an apparatus to perform at least the following: generate at least one bitstream, wherein the bitstream comprises: at least one audio signal; at least one anchor parameter associated with the at least one audio signal; and information configured to assist in the adaptation of the at least one audio scene anchor parameter with at least one further anchor parameter within an audio scene within which the at least one audio signal is to be rendered.

According to a twenty-fourth aspect there is provided a computer readable medium comprising program instructions for causing an apparatus to perform at least the following: determine, for the audio scene, at least one audio scene anchor parameter; obtain, from at least one further apparatus a bitstream, the bitstream comprising: the at least one audio signal; at least one anchor parameter associated with the at least one audio signal; and information configured to assist in the adaptation of the at least one anchor parameter with the at least one audio scene anchor parameter; associate the at least one anchor parameter with the at least one audio scene anchor parameter based on the information configured to assist in the adaptation of the at least one anchor parameter with the at least one audio scene anchor parameter; and render the at least one audio signal based on the association between the at least one anchor parameter with the at least one audio scene anchor parameter.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1a shows schematically a suitable environment showing an example of a combination of virtual scene elements within a physical listening space;

FIG. 1b shows schematically an example environment mesh describing the physical listening space and an anchor element;

FIG. 1c shows example anchor mappings including a simple one-to-one-mapping and a multiple or incomplete mapping;

FIG. 2 shows schematically a system of apparatus for implementing an example capture to rendering for an augmented reality scene according to some embodiments;

FIG. 3 shows a flow diagram of the operation of the system of apparatus as shown in FIG. 2 according to some embodiments;

FIG. 4 shows schematically an example renderer as shown in FIG. 2 according to some embodiments;

FIG. 5 shows schematically a further example renderer as shown in FIG. 2 according to some embodiments;

FIG. 6 shows a flow diagram of the operations within the renderers as shown in FIGS. 4 and 5 according to some embodiments; and

FIG. 7 shows schematically an example device suitable for implementing the apparatus shown.

### EMBODIMENTS OF THE APPLICATION

The following describes in further detail suitable apparatus and possible mechanisms for rendering a consistent adaptation of an augmented (AR) scene experience and providing handling scenarios where a bitstream contains anchor references which may not have a one-to-one correspondence with the anchors in the listening space description.

The concept as discussed further in the embodiments herein is one wherein guidance metadata is included within the bitstream generated by the content provider and which can then be employed for consistent adaptation of anchor references in the bitstream with the anchors in the listening space description.

The result of such embodiments achieve a predictable and consistent rendering experience in potentially different listening environments as well as varying implementations for creating listening space descriptions.

In some embodiments, the guidance metadata is employed to achieve consistent correspondence between the bitstream anchor references and the listening space anchors by implementing filtering criteria. In some embodiments the filtering can be spatial filtering (e.g., nearest), temporal filtering (e.g., earliest available anchor), or a prioritized list of candidate mappings.

In some further embodiments, the filtering criteria is configured to take into account the renderer processing level to account for the permitted audio element addition in the audio rendering pipeline. For example, if the renderer processing level only permits one-to-one audio-to-anchor mapping if the number of elements rendered crosses a predefined threshold number, multiple mappings are not performed even if permitted in the bitstream.

Thus the content creator bitstream permits multiple instances depending on the anchor mappings in the listening space. However, this number is an upper bound which can be constrained by the profile or the permitted number of instances depending on the renderer hardware. In otherwords, in some embodiments, the codec profile or renderer hardware capability can constrain the number of instances spawned due to the rendering adaptation bitstream. As a concrete example, if a content creator bitstream permits “all” anchor mappings in the listening space to be rendered, and 50 instances of the anchor “table” is obtained from the listening space, the current profile may have a budget of 50 audio objects but the audio scene consists of other 40 audio objects. In such a case, the renderer may constrain the number of instances to say 10 for the anchor mapping. In another scenario, the constraint may be due to the renderer hardware specified constraints.

As discussed above a listening space description, information which describes acoustically the physical space within which the user is located may be derived by the AR rendering device.

In some embodiments the listening space is defined by a mesh of listening space faces. The listening space description in some embodiments is obtained during content consumption. This is in contrast to the content creator scene description which is available during content creator bitstream creation and is delivered as part of the 6DoF bitstream to the renderer. The content creator bitstream has hooks (i.e. anchors) to map the scene elements to the listening space during content consumption.

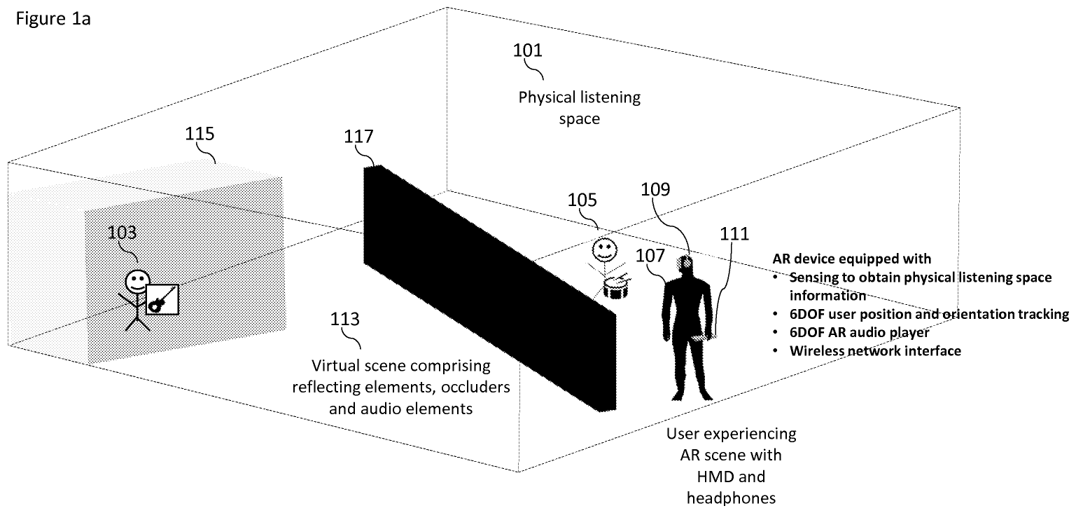

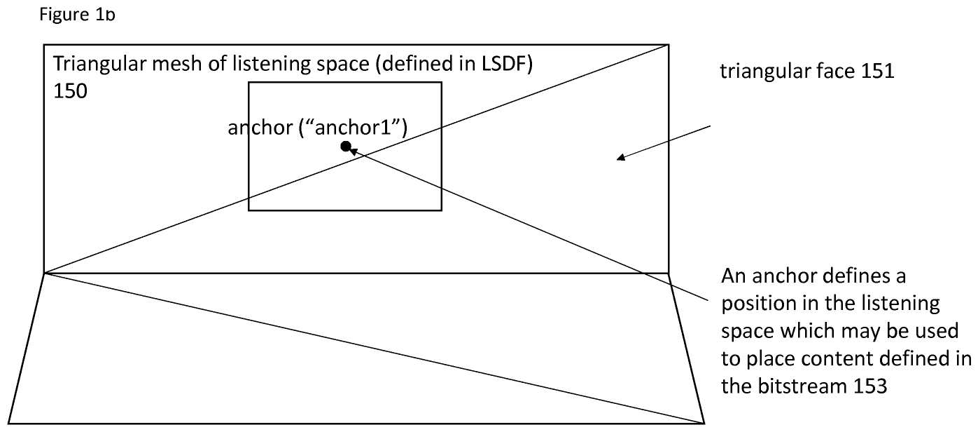

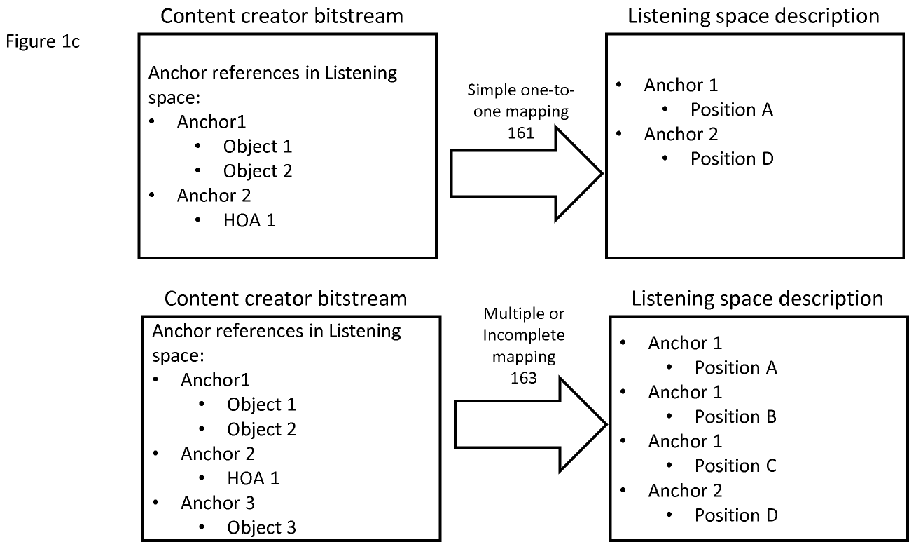

The embodiments described herein provides a method for enabling the consistent adaptation of the content creator specified preferences. This is because the listening space descriptions will vary for every listening space. Depending on the implementation, it is expected that there will be differences in the listening space descriptions provided to the immersive audio renderer. For example FIG. 1b shows an example listening space comprising a wall and floor. The listening space is defined by a triangular mesh 150 which is divided up into suitable polygons. In this example the polygons are triangles 151. These faces can have associated material and reverberation/absorption/reflection properties. The physical listening space parameters (which may be in a Listening Space Description File (LSDF) format) may contain information on where in the listening space geometry certain elements that are defined in the geometry are placed. In some implementations the physical listening space may furthermore comprise an ‘anchor’ located within the listening space which may be used to define an origin from which a location of one or more (virtual or augmented) audio sources can be defined. For example the anchor may be located on a wall within the listening space, or the anchor may be located in the middle of a room or, for example, located at a statue's mouth which is augmented with a virtual hat and audio object associated with the position of the statue's mouth). The one or more (virtual or augmented) audio sources and their properties (e.g., relative position with respect to the anchor) can be defined in the EIF/bitstream.

An example of which is shown in FIG. 1b by anchor “anchor 1” 153 which may define a position in the listening space which may be used to place content defined in the bitstream.

Additionally a content creator may be able to define anchor points which are associated with one or more audio elements and which are configured in the renderer to be mapped to an anchor as defined within the listening space.

For example, below is an example content creator scene description which indicates to the renderer to associate one or more audio elements to the listening space information indicating position of “picture_anchor” as marked in bold.

```
<Anchor id=“tf:picture_on_the_wall” lsdf_{—}ref=“picture_{—}anchor”>
  <ObjectSource id=“src:voice” position=“...” ... />
  <Box id=“ext:picture” ... />
</Anchor>
```

As can be envisioned, if the listening space description obtained by the renderer contains multiple (or no) anchors with the same reference (“picture_anchor” in the example), the renderer may either render an incomplete or inaccurate audio scene. This can result in a poor, unpredictable and inconsistent rendering experience. This may happen when the AR rendering device determines multiple (or none) suitable anchor positions (multiple pictures in the listening space). It is not clear that which of these positions should be used when placing the object source.

As such the embodiments discussed herein are configured to handle the simple one-to-one mapping 161 as shown in FIG. 1c where the content creator bitstream comprises information such as

Anchor references in Listening space:
Anchor1
   Object 1
   Object 2
Anchor 2
   HOA 1

and the renderer is able to identify listening space description
Anchor 1
   Position A
Anchor 2
   Position D
      In this example object 1 and object 2 can be mapped such that they are accurately located with respect to position A and Higher Order Ambisonics 1 (HOA 1) are accurately located with respect to position D.

Additionally the embodiments as discussed herein are configured to produce consistent multiple or incomplete mapping 163 as shown in FIG. 1c where the content creator bitstream comprises information such as

Anchor references in Listening space:
Anchor1
   Object 1
   Object 2
Anchor 2
   HOA 1
Anchor 3
   Object 3

and the renderer is able to identify listening space description
Anchor 1
   Position A
Anchor 1
   Position B
Anchor 1
   Position C
Anchor 2
   Position D

In this example a simple one-to-one mapping may fail as the anchor 1 is defined at three locations and there is no mapping from the anchor defined as anchor 3 with the listening space description defined information.

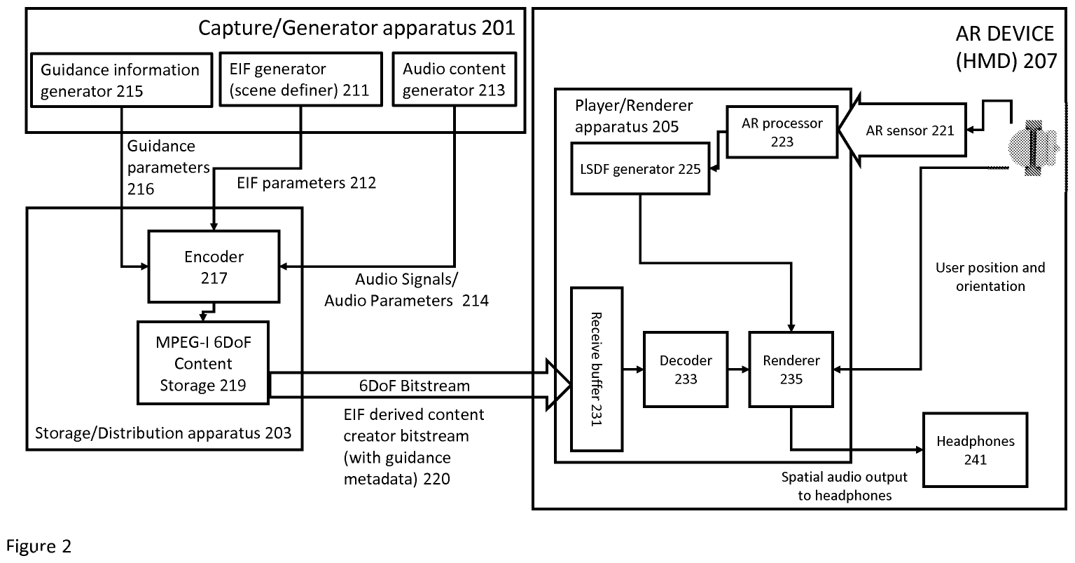

FIG. 2 gives an overview of the end to end AR/XR 6DoF audio system. There are shown in the example three parts of the system, the capture/generator apparatus 201 configured to capture/generate the audio information and associated metadata, the storage/distribution apparatus 203 configured to encode and store/distribute the audio information and associated metadata and the augmented reality (AR) device 207 configured to output a suitable processed audio signal based on the audio information and associated metadata. The AR device 207 in the example shown in FIG. 2 has the 6DoF audio player 205 which renders retrieves the 6DoF bitstream from the storage/distribution apparatus 203 and renders it.

In some embodiments as shown in FIG. 2 the capture/generator apparatus 201 comprises an encoder input format (EIF) generator 211. The encoder input format (EIF) generator 211 (or in more general the scene definer) is configured to define the 6DoF audio scene. In some embodiments the scene may be described by the EIF (encoder input format) or any other suitable 6DoF scene description format. The EIF also references the audio data comprising the audio scene. The encoder input format (EIF) generator 211 is configured to create EIF (Encoder Input Format) data, which is the content creator scene description. The scene description information contains virtual scene geometry information such as positions of audio elements. Furthermore the scene description information may comprise other associated metadata such as directivity and size and other acoustically relevant elements. For example the associated metadata could comprise positions of virtual walls and their acoustic properties and other acoustically relevant objects such as occluders. An example of acoustic property is acoustic material properties such as (frequency dependent) absorption or reflection coefficients, amount of scattered energy, or transmission properties. In some embodiments, the virtual acoustic environment can be described according to its (frequency dependent) reverberation time or diffuse-to-direct sound ratio. The EIF generator 211 in some embodiments may be more generally known as a virtual scene information generator. The EIF parameters 214 can in some embodiments be provided to a suitable (MPEG-1) encoder 217.

Furthermore in some embodiments the encoder input format (EIF) generator 211 is configured to generate anchor reference information. The anchor reference information may be defined in the EIF to indicate that the position of the specified audio elements are to be obtained from the listener space via the LSDF.

In some embodiments the anchor definitions and bitstream structures are indicated without the guidance metadata for AR adaptation.

The structures Anchor( ), AnchorsStruct( ) and ContentCreatorSceneDescriptionStruct( ) are the structures that describe the audio scene information with references to the listening space description.

```
  aligned(8) BasicAnchorStruct( ){
    unsigned int(16) index;//anchor index
    string lsdf_ref;//corresponding anchor identifier in
the listening space description
  AudioElementsStruct( );//audio elements associated
with this anchor
  GeometryElementsStruct( );//scene geometry elements
associated with this anchor
  }
  aligned(8) AnchorsStruct( ){
    unsigned int(16) num_anchors;
    for(i=0;i<num_anchors;i++){
      BasicAnchor( );
    }
  }
  aligned(8) ContentCreatorSceneDescriptionStruct( )
    Anchors( );
    VirtualSceneDescription( );
  }
```

The ContentCreatorsceneDescriptionstruct( ) structure has the MHAS packet type PACTYP_CCSD, MHASPacketLabel will be the same value as that of the MPEG-H content.

In some embodiments the capture/generator apparatus 201 comprises an audio content generator 213. The audio content generator 213 is configured to generate the audio content corresponding to the audio scene. The audio content generator 213 in some embodiments is configured to generate or otherwise obtain audio signals associated with the virtual scene. For example in some embodiments these audio signals may be obtained or captured using suitable microphones or arrays of microphones, be based on processed captured audio signals or synthesised. In some embodiments the audio content generator 213 is furthermore configured in some embodiments to generate or obtain audio parameters associated with the audio signals such as position within the virtual scene, directivity of the signals. The audio signals and/or parameters 212 can in some embodiments be provided to a suitable (MPEG-1) encoder 217.

Furthermore in some embodiments the capture/generator apparatus 201 comprises a guidance information generator 215. The guidance information generator 215 is configured to generate suitable guidance information metadata 216. The guidance information metadata is configured to assist in the mapping operation in the renderer as described in further detail herein.

In the following, the guidance metadata for consistent adaptation of the 6DoF audio scene is described. The guidance metadata in some embodiments can for example be guidance to handle a alternative anchor references in a prioritized order (e.g., to handle the case of placing an audio object on top of a table if the ground is not visible clearly to the AR device).

In some embodiments the guidance metadata is configured to control the default placement (or mapping) of anchors in the content creator bitstream if there are missing anchors in the listening space description.

Furthermore in some embodiments the guidance metadata comprises information which enables mapping of multiple anchors in the listening space description for the references in the content creator bitstream.

In some embodiments the guidance information may be implemented or inserted within the anchor definition. In other words the anchor definition or structures are modified or enhanced to include additional information in the bitstream to handle the different listening space descriptions received by the 6DoF player and subsequently the renderer.

```
  aligned(8) AnchorWithAdaptation( ){
  unsigned int(1)
alternative_lsdf_references_present;//prioritized list of
anchor mapping options. The anchors present in LSDF are
selected in priority order
  unsigned int (1) default_placement_if_anchor_missing;//if
0, placement skipped and if 1, default placement information
present
  unsigned int(1)
lsdf_references_filtering_present;//filtering metadata if
multiple anchors present in LSDF for an anchor in content
creator bitstream
  unsigned int(1)
dynamic_anchor_update_present;//continuous update of anchor
position or the properties of the associated audio elements or
scene elements
  bit(4) reserved = 0;
  if(alternative_lsdf_references_present){
    AlternativeAnchorsStruct( );
  }
  if(lsdf_references_filtering_present){
    FilterEnabledAnchorStruct( );
  }
  if(default_placement_if_anchor_missing){
    DefaultPlacementAnchorsStruct( );
  }
  if(dynamic_anchor_update_present){
    DynamicAnchorStruct( );
  }
}
```

In some embodiments alternative anchor selection metadata in the content creator bitstream for the anchor references in the listening space description can be as follows.

```
  aligned(8) AlternativeAnchorsStruct( ){
  unsigned int(8) num_anchors_with_alternatives;//the
alternatives are ordered in priority
  unsigned int(8) num_alternatives_per_anchor;//the
alternatives are ordered in priority
  BasicAnchor( );
  for(i=0; i<num_alternatives_per_anchor){
    string lsdf ref string; //anchors obtained from LSDF
  }
}
```

In some embodiments filtering metadata for anchor selection can be provided in the content creator bitstream for the anchor references in the listening space description with multiple anchors.

```
  aligned(8) FilterEnabledAnchorStruct( ){
    BasicAnchor( );//Basic anchor as in LSDF
    AnchorFilterStruct( );
}
  aligned(8) AnchorFilterStruct( ){
  unsigned int(1) spatial_filter_present;
  unsigned int(1) temporal_filter_present;
  if(spatial_filter_present){
    unsigned int(4) spatial_filter_type;
    unsigned int(4) num_mappings_allowed;
    unsigned int(4) auralization_type;
  }
  if(temporal_filter_present){
    unsigned int(4) temporal_filter_type;
    unsigned int(4) mappings_modification_type;
  }
}
```

In some embodiments the following options are available if spatial_filter_present flag is equal to 1:

| spatial_{—} | |
|---|---|
| filter_type | value |
| 0 | Nearest anchor selection to the listener's current |
| | position and nearest to the current orientation. |
| 1 | Farthest anchor selection to the listener's current |
| | position. |
| 2 | Anchor selection with maximal spread (e.g., distribute |
| | the number of instances evenly around the user). |
| 3 | Interactive selection by the user. |
| 4-15 | Reserved |
| auralization_{—} | |
| type | value |
| 0 | All instances in case of multiple mapping will undergo |
| | default full auralization processing. (e.g., as described |
| | in the respective audio element metadata) |
| 1 | Only the nearest will undergo full processing the other |
| | instances can be candidates for cluster processing. |
| 2 | Only one instance will have extent processing, which |
| | one depends on the spatial filter criteria (e.g., nearest, |
| | user selected, etc.). |
| 3 | Interactive selection by the user. |
| 4 | Only the selected ones (one or more) by filtering are |
| | rendered with full auralization, others are rendered as |
| | point sources. |
| 5 | Only the mapping within the user's orientation cone |
| | (e.g., orientation +/−60 degrees azimuth and elevation) |
| | direction are rendered with full processing |
| 6-15 | Reserved |

In some embodiments the following options available if temporal_filter_present flag is equal to 1:

| temporal_{—} | |
|---|---|
| filter_type | Value |
| 0 | Earliest anchor without later modifications. |
| 1 | Earliest anchor with later modifications (e.g., if |
| | nearest anchor changes due to user movement). |
| 2 | Anchor selection with maximal spread (e.g., |
| | distribute the number of instances evenly around |
| | the user). |
| 3 | Interactive selection by the user. |
| 4-15 | Reserved |
| Mappings_{—} | |
| modification_{—} | |
| type | Value |
| 0 | Change in number of instances not allowed. |
| 1 | Change in number of instances allowed. |
| 2 | Auralization changes for the mapped audio |
| | elements not allowed. |
| 3 | Auralization changes for the mapped audio |
| | elements is allowed (e.g., clustering, making |
| | extended source to point source, etc.). |
| 4-15 | Reserved |

In some embodiments the guidance comprises default placement metadata for anchors which are missing in the listening space description.

```
aligned(8) DefaultPlacementAnchorsStruct( ){
  unsigned int(8) num_default_placements;//these may not be
present for all anchors
  BasicAnchor( );//index of anchor in EIF
  for(i=0; i<num_default_placements){
    Location( );//default placement in absence of anchor
in LSDF
  }
}
aligned(8) Location( ){
  signed int(32) pos_x;
  signed int(32) pos_y;
  signed int(32) pos_z;
  signed int(32) orient_yaw;
  signed int(32) orient_pitch;
  signed int(32) orient_roll;
  unsigned int(1) cspace;//with respect to listening space
origin if 1 with respect to user if 0
  bit(7) reserved = 0;
}
```

In some embodiments the guidance information is determined based on the anchors being dynamic. In other words the listening space description may consist of anchors which may be dynamic i.e. changing position and potentially properties at a continuous basis. For example, the audio scene may consist of a virtual audio object following a moving anchor.

To enable this the anchor object may also have dynamic update capability. The dynamic update can be a capability already attached to an audio anchor in the content creator bitstream. This enables the 6DoF player to prepare and be ready to receive the dynamic updates regarding the particular anchor during content consumption.

The difference between listening space description update and an anchor which is moving is within the frequency of update. The listening space update relates to the entire listening space and is updated whenever the AR sensing interface of the AR device obtains new information which necessitates creation of a new listening space description. The dynamic updates for a moving anchor can occur at a much higher frequency depending on the position sampling frequency to obtain smooth translation effect without jerkiness or delay.

```
  aligned(8) DynamicAnchorStruct( ){
  unsigned int(4) dynamic_update_type;
  bit(4) reserved = 0;
}
```

the options for this structure can in some embodiments be as follows.

| Dynamic_{—} | |
|---|---|
| update_type | Value |
| 0 | Infrequent updates with immediate response expected. |
| 1 | Frequent updates expected, no filtering to be applied. |
| 2 | Renderer side filtering without look ahead prediction. |
| 3 | Heavy “S” curve filtering which minimizes oscillations. |
| 4-15 | Reserved |

In some embodiments the guidance information is passed to the encoder 217.

In some embodiments of the implementation, the guidance information can be part of the scene description and delivered as part of the EIF information, in such a case, a separate guidance information may not be required. As such in some embodiments the guidance information generator 215 is incorporated within the EIF generator 211 and the guidance information generated as part of the EIF information.

In some embodiments the storage/distribution apparatus 203 comprises an encoder 217. The encoder is configured to receive the EIF parameters 212, the audio signals/audio parameters 214 and the guidance parameters or information 216 and encode these to generate a suitable bitstream.

The encoder 217 for example can use the EIF parameters 212, the audio signals/audio parameters 214 and the guidance parameters 216 to generate the MPEG-I 6DoF audio scene content which is stored in a format which can be suitable for streaming over the network. The delivery can be in any suitable format such as MPEG-DASH (Dynamic Adaptive Streaming Over HTTP), HLS (HTTP Live Streaming), etc. The 6DoF bitstream carries the MPEG-H encoded audio content and MPEG-I 6DoF bitstream. The content creator bitstream generated by the encoder on the basis of EIF and audio data can be formatted and encapsulated in a manner analogous to MHAS packets (MPEG-H 3D audio stream). The encoded bitstream in some embodiments is passed to a suitable content storage module. For example as shown in FIG. 2 the encoded bitstream is passed to a MPEG-I 6DoF content storage 219 module. Although in this example the encoder 217 is located within the storage/distribution apparatus 203 it would be understood that the encoder 217 can be part of the capture/generator apparatus 201 and the encoded bitstream passed to the content storage 219.

In some embodiments the storage/distribution apparatus 203 comprises a content storage module. For example as shown in FIG. 2 the encoded bitstream is passed to a MPEG-I 6DoF content storage 219 module. In such embodiments the audio signals are transmitted in a separate data stream to the encoded parameters. In some embodiments the audio signals and parameters are stored/transmitted as a single data stream or format or delivered as multiple data streams.

The content storage 219 is configured to store the content (including the EIF derived content creator bitstream with guidance metadata) and provide it to the AR device 207.

In some embodiments the capture/generator apparatus 201 and the storage/distribution apparatus 203 are located in the same apparatus.

In some embodiments the AR device 207 which may comprise a head mounted device (HMD) is the playback device for AR consumption of the 6DoF audio scene.

The AR device 207 in some embodiments comprises at least one AR sensor 221. The at least one AR sensor 221 may comprise multimodal sensors such as visual camera array, depth sensor, LiDAR, etc. The multimodal sensors are used by the AR consumption device to generate information of the listening space. This information can comprise material information, objects of interest, etc. This sensor information can in some embodiments be passed to an AR processor 223.

In some embodiments the AR device 207 comprises a player/renderer apparatus 205. The player/renderer apparatus 205 is configured to receive the bitstream comprising the EIF derived content creator bitstream (with guidance metadata) 220, the AR sensor information and the user position and/or orientation and from this information determine a suitable audio signal output which is able to be passed to a suitable output device, which in FIG. 2 is shown as headphones 241 (which may be incorporated within the AR device 207.

In some embodiments the player/renderer apparatus 205 comprises an AR processor 223. The AR processor 223 is configured to receive the sensor information from the at least one AR sensor 221 and generate suitable AR information which may be passed to the LSDF generator 225. For example, in some embodiments, the AR processor is configured to perform a fusion of sensor information from each of the sensor types.

In some embodiments the player/renderer apparatus 205 comprises a listening space description file (LSDF) generator 225. The listening space description file (LSDF) generator 225 is configured to receive the output of the AR processor 223 and from the information obtained from the AR sensing interface generate the listening space description for AR consumption. The format of the listening space can be in any suitable format. The LSDF creation can use the LSDF format. This description carries the listening space or room information including acoustic properties (e.g., mesh enveloping the listening space including materials for the mesh faces), audio elements or geometry elements of the scene with spatial locations that are dependent on the listening space are referred to as anchors in the listening space description. The anchors may be static or dynamic in the listening space. The LSDF generator is configured to output this listening scene description information to the renderer 235.

In some embodiments the player/renderer apparatus 205 comprises a receive buffer 231 configured to receive the content creator bitstream 220 comprising the EIF information and with guidance metadata. As indicated above the guidance metadata may or may not be separate from the EIF information. The buffer 231 is configured to pass the received data and pass the data to a decoder 233.

In some embodiments the player/renderer apparatus 205 comprises a decoder 233 configured to obtain the encoded bitstream from the buffer 231 and output decoded EIF information and decoded guidance information (with decoded audio data when it is within the same data stream) to the renderer 235. The guidance information may be delivered with or without any compression, in the latter case only a parser is required.

In some embodiments the player/renderer apparatus 205 comprises a renderer 235. The renderer 235 is configured to receive the decoded EIF information and decoded guidance information (with decoded audio data when it is within the same data stream), the listening scene description information and listener position and/or orientation information. The listener position and/or orientation information can be obtained from the AR device configured with suitable listener tracking apparatus and sensors which enable providing accurate listening position as well as orientation. The renderer 235 is further configured to generate the output audio signals to be passed to the output device, as shown in FIG. 2 by the spatial audio output to the headphones 241.

The renderer 235 is configured to obtain the content creator bitstream (i.e. MPEG-I 6DoF bitstream which carries references to anchors in LSDF) and LSDF (i.e. anchor position in the actual listening space) and then be configured to implement a correspondence mapping such that the anchors in the content creators are mapped to the anchors within the listening space description information.

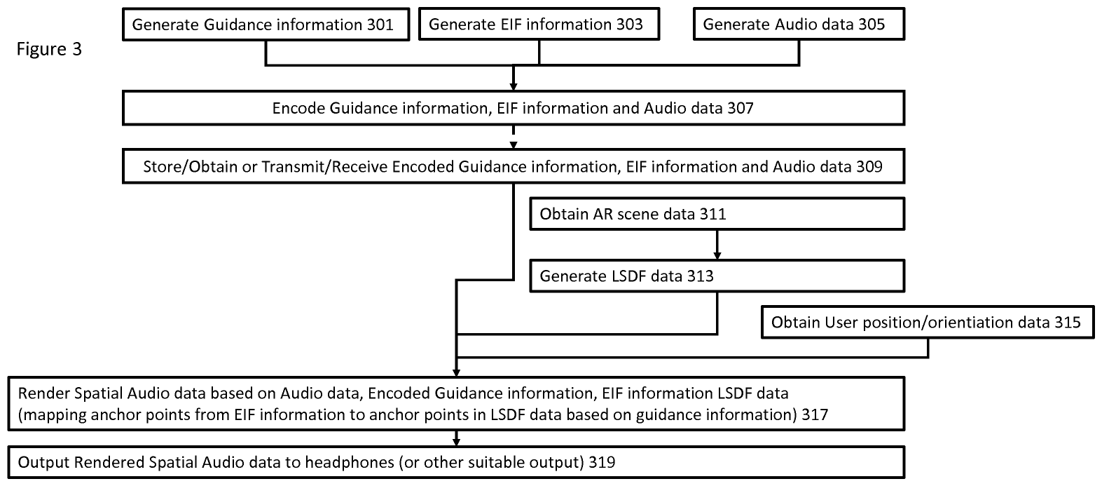

With respect to FIG. 3 is shown an example operation of the system shown in FIG. 2.

The method may comprise generating or otherwise obtaining guidance information as shown in FIG. 3 by step 301.

Furthermore the EIF information is generated (or obtained) as shown in FIG. 3 by step 303.

The audio data is furthermore obtained (or generated) as shown in FIG. 3 by step 305.

The guidance information, EIF information, and audio data is then encoded as shown in FIG. 3 by step 307.

The encoded data is then store/obtained or transmitted/received as shown in FIG. 3 by step 309.

Additionally the AR scene data is obtained as shown in FIG. 3 by step 311.

From the sensed AR scene data a listening space description (file) information is generated as shown in FIG. 3 by step 313.

Furthermore the listener/user position and/or orientation data can be obtained as shown in FIG. 3 by step 315.

Then spatial audio signals can be rendered based on the audio data, the guidance information, the EIF information, LSDF data and the position and/or orientation data. Specifically the rendering comprises mapping anchor points from EIF information to anchor points in LSDF data based on guidance information as shown in FIG. 3 by step 317. In some embodiments of the implementation, the guidance information can be part of the scene description and delivered as part of the EIF information, in such a case, a separate guidance information may not be required.

Having rendered spatial audio signals these can be output to a suitable output device, such as headphones as shown in FIG. 3 by step 319.

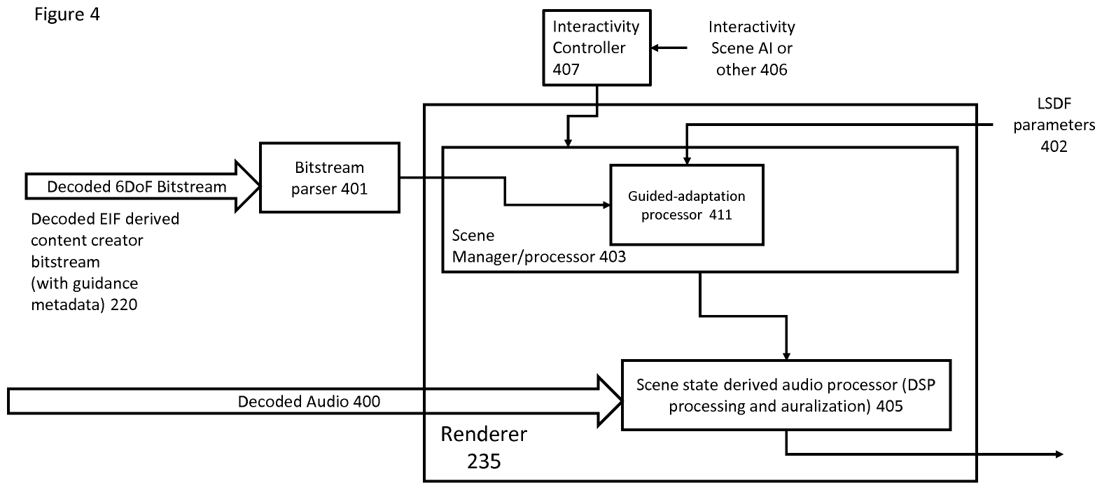

FIG. 4 shows an example renderer 235 suitable for implementing some embodiments and can be configured to implement anchor mapping (which may also be known as fused scene representations) even for variance in the listening space description provided to the renderer. Examples of variance include: missing anchors, single to multiple anchor mappings, anchors which are shifting.

FIG. 4 shows, for example, that before the renderer 235 a bitstream parser 401 configured to receive the decoded 6DoF bitstream. The parsed EIF and guidance data can then be passed to a scene manager/processor 403.

The renderer 235 in some embodiments comprises a scene manager/processor 403. The scene manager/processor 403 is configured to receive the parsed EIF and guidance data from the bitstream parser 401, The LSDF parameters 402 and further the interactivity controller output from the interactivity controller 407.

The scene manager/processor 403 in some embodiments comprises a guided adaptation processor 411 which is configured to implement anchor mapping (or generate fused scene representations) based on the parsed EIF and guidance data, the LSDF parameters and controlled by the interactivity controller output. The guided adaptation processor 411 thus attempts to ensure that only the desired (based on content creator guidance metadata) audio elements are instantiated in the scene state.

The output of the guided adaptation processor 411 (and the scene manager/processor 403) is configured such that any subsequent spatial audio signal processing (or auralization pipeline) can be agnostic to the type of AR adaptation required to handle the different variations in the LSDFs which the renderer may receive. Furthermore, the guided adaptation processor 411 is configured to receive inputs for anchor selection.

In some embodiments the renderer 235 and specifically the scene manager/processor 403 is configured to obtain an interactivity controller output from an interactivity controller 407. The interactivity controller 407 is configured to generate a control output based on an input 406. For example the input can be a user selection input from a suitable user interface and can be from the listener. In some embodiments the input can be from a suitable AI module which performs run-time selection based on its own optimization logic or some other method. The interactivity controller output is thus configured to enable a versatile anchor mapping/selection mechanism. The mechanism can be configured in some embodiments to be employed in conjunction to the guidance metadata (e.g., when such a selection method is permitted in the metadata). Further in some embodiments the mechanism can be employed in addition to the explicit guidance metadata in the bitstream. Additionally in some embodiments the mechanism can be employed complementary to the guidance metadata.

The scene management information can then be passed to the audio processor 405 configured to obtain the audio signals, the processed scene information and the listeners position and/or orientation and from these generate the spatial audio signal output. As indicated above the effect of the scene manager/processor 403 is such that any known or suitable spatial audio processing implementation can be employed (the auralisation pipeline being agnostic to the earlier scene processing).

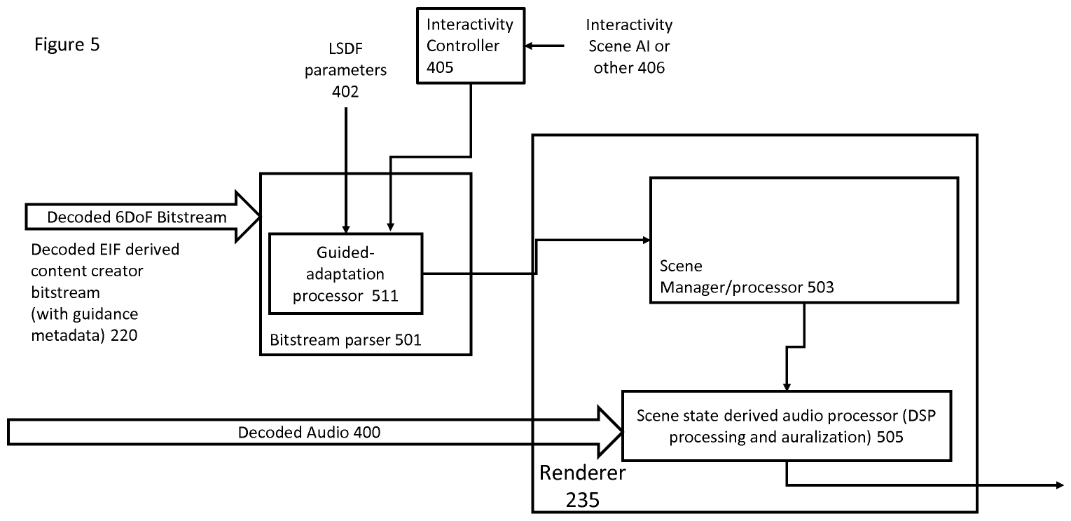

With respect to FIG. 5 is shown a further implementation embodiment of the renderer 235 according to some embodiments. In this implementation the difference is such that the guided-adaptation processor 511 is implemented within the bitstream parser 501 and the output of which is passed to the scene manager/processor 503. In other words the adaptation is implemented during the bitstream parsing. In such embodiments different implementation embodiments are possible depending on the deployment specific requirements of the AR device platform. The approach as implemented in FIG. 5 may be agnostic to the entire renderer (e.g., an off-the-shelf 6DoF renderer can be employed). Thus a renderer which does not support AR rendering or LSDF can also be made AR compatible.

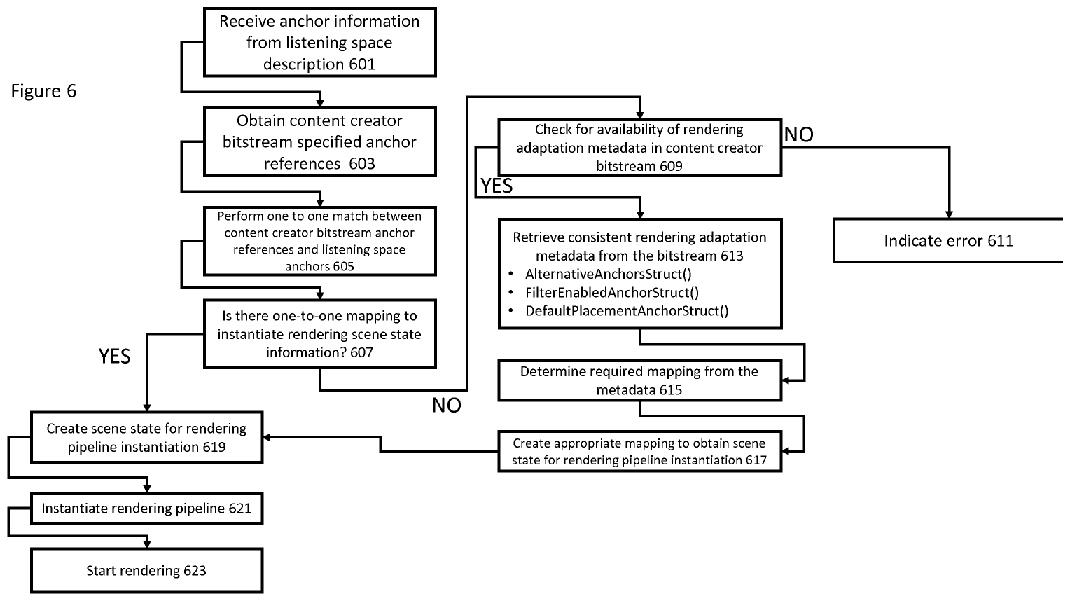

With respect to FIG. 6 is shown an example flow diagram showing the operation of the guided adaptation processor 411/511 as shown in some embodiments.

The anchor information is received or obtained from listening space description as shown in FIG. 6 by step 601.

Additionally the content creator bitstream information specified anchor references are received or obtained as shown in FIG. 6 by step 603.

A one to one match or mapping between content creator bitstream anchor references and listening space anchors is then attempted or performed as shown in FIG. 6 by step 605.

A check is then made to determine whether the one to one match or mapping between content creator bitstream anchor references and listening space anchors is achieved as shown in FIG. 6 by step 607.

Where the step 607 check fails and there is no completed one-to-one match or mapping then a check is performed to determine whether there is any (guidance information) or rendering adaptation metadata in content creator bitstream as shown in FIG. 6 by step 609.

Where the step 609 check fails (there is no guidance information found) then an error is generated (and the rendering controlled based on the error) as shown in FIG. 6 by step 611.

Where the step 609 check passes (there is guidance information) then the rendering adaptation metadata is retrieved from the bitstream, for example the following structures can be obtained: AlternativeAnchorsStruct( ); FilterEnabledAnchorStruct( ); DefaultPlacementAnchorStruct( ) as shown in FIG. 6 by step 613. These are examples of the guidance metadata, different implementation embodiments may choose to group the guidance information according to implementation specific preferences.

Then based on the guidance information (rendering adaptation metadata is retrieved from the bitstream) then the required mappings are determined as shown in FIG. 6 by step 615.

Furthermore the appropriate mappings are then created to obtain the scene state for rendering pipeline instantiation as shown in FIG. 6 by step 617.

Where the step 607 check passes (there is a completed one-to-one match or mapping) or when the guidance information based match(es) or mapping(s) is generated then the scene state for rendering pipeline instantiation is created as shown in FIG. 6 by step 619.

Then the rendering pipeline is instantiated as shown in FIG. 6 by step 621.

Finally the rendering is then started as shown in FIG. 6 by step 623.

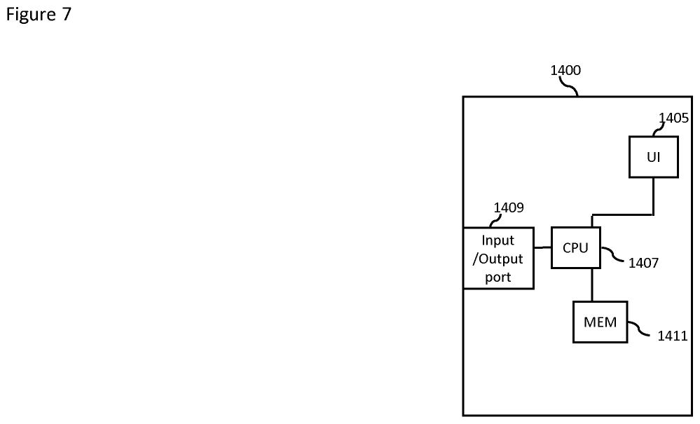

With respect to FIG. 7 an example electronic device which may represent any of the apparatus shown above. The device may be any suitable electronics device or apparatus. For example in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware.

The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus, comprising:
at least one processor; and
at least one non-transitory memory storing instructions that, when executed with the at least one processor, cause the apparatus at least to:
obtain at least one audio signal;
obtain at least one anchor parameter associated with the at least one audio signal; and
obtain information configured to assist in an adaptation of the at least one anchor parameter with at least one further anchor parameter within an audio scene within which the at least one audio signal is to be rendered.

2. The apparatus as claimed in claim 1, wherein information configured to assist in the adaptation comprises at least one of:
guidance metadata configured to assist in the adaptation of the at least one anchor parameter with at least one further anchor parameter within the audio scene within which the at least one audio signal is to be rendered; or
information configured to define a geometry of a virtual or augmented audio scene wherein the at least one anchor parameter defines a position with respect to the virtual or augmented audio scene geometry.

3. The apparatus as claimed in claim 1 wherein the instructions, when executed with the at least one processor, cause the apparatus to obtain information to obtain at least one of:
a spatial filtering parameter configured to control a mapping of at least one audio element anchor to at least one anchor within the audio scene within which the at least one audio signal is to be rendered based on a distance between the one audio element anchor and the at least one anchor within the audio scene;
a temporal filtering parameter configured to control a mapping of at least one audio element anchor to at least one anchor within the audio scene within which the at least one audio signal is to be rendered based on a time difference between the one audio element anchor and the at least one anchor within the audio scene; or
a priority list parameter configured to control a mapping of at least one audio element anchor to at least one anchor within the audio scene within which the at least one audio signal is to be rendered based on a priority list of candidate mappings.

4. The apparatus as claimed in claim 1, wherein the instructions, when executed with the at least one processor, cause the apparatus to obtain information to obtain a processor filtering parameter configured to control a mapping of at least one audio element anchor to at least one anchor within the audio scene based on a renderer processor value.

5. The apparatus as claimed in claim 1, wherein the instructions, when executed with the at least one processor, cause the apparatus to obtain information obtain at least one of:
an alternative anchor filtering parameter configured to control a mapping of the at least one audio element anchor to an alternative one of at least one anchor within the audio scene where there is no matching label between the at least one audio element anchor and the at least one anchor within the audio scene;
a default position parameter configured to control a positioning of the at least one audio element anchor within the audio scene where there is no matching label between the at least one audio element anchor and the at least one anchor within the audio scene; or
a multiple anchors parameter comprising identifiers identifying at least two candidate anchors within the audio scene and configured to control a mapping to at least one of the candidate anchors within the audio scene based on at least one of the candidate anchors being located within the audio scene.

6. The apparatus as claimed in claim 1, wherein the instructions, when executed with the at least one processor, cause the apparatus to obtain information to obtain an instance processing parameter configured to control a processing of instances of a mapping of the at least one audio element anchor to at least one of the at least one anchor within the audio scene.

7. The apparatus as claimed in claim 1, wherein the instructions, when executed with the at least one processor, cause the apparatus to obtain information to obtain a mapping modification processing parameter configured to control whether a mapping modification or processing of instances of a mapping of the at least one audio element anchor to at least one of the at least one anchor within the audio scene.

8. An apparatus as claimed in claim 1, wherein the instructions, when executed with the at least one processor, cause the apparatus to: generate at least one bitstream, wherein the bitstream comprises:
the at least one audio signal;
the at least one anchor parameter associated with the at least one audio signal; and
the information configured to assist in the adaptation of the at least one audio scene anchor parameter with the at least one further anchor parameter within the audio scene within which the at least one audio signal is to be rendered.

9. (canceled)

10. An apparatus for rendering at least one audio signal within an audio scene, the apparatus comprising:
at least one processor; and
at least one non-transitory memory storing instructions that, when executed with the at least one processor, cause the apparatus at least to:
determine, for the audio scene, at least one audio scene anchor parameter;
obtain, from at least one further apparatus, a bitstream comprising:
the at least one audio signal;
at least one anchor parameter associated with the at least one audio signal; and
information configured to assist in the adaptation of the at least one anchor parameter with the at least one audio scene anchor parameter;
associate the at least one anchor parameter with the at least one audio scene anchor parameter based on the information configured to assist in the adaptation of the at least one anchor parameter with the at least one audio scene anchor parameter; and
render the at least one audio signal based on the association between the at least one anchor parameter with the at least one audio scene anchor parameter.

11. The apparatus as claimed in claim 10, wherein the at least one audio scene anchor parameter is configured to define at least one of:
a position within the audio scene; or
a number of instances within the audio scene.

12. The apparatus as claimed in claim 10, wherein the information configured to assist in the adaptation comprises at least one of:
guidance metadata configured to assist in the adaptation of the at least one anchor parameter with at least one further anchor parameter within an audio scene within which the at least one audio signal is to be rendered;
information configured to define a geometry of a virtual or augmented audio scene wherein the at least one anchor parameter defines a position with respect to the virtual or augmented audio scene geometry.

13. The apparatus as claimed in claim 10, wherein the information configured to assist in the adaptation is at least one of:
a spatial filtering parameter, wherein the instructions, when executed with the at least one processor, cause the apparatus to associate the at least one anchor parameter with the at least one audio scene anchor parameter to control a mapping of at least one audio element anchor to at least one anchor within the audio scene within which the at least one audio signal is to be rendered based on a distance between the one audio element anchor and the at least one anchor within the audio scene;
a temporal filtering parameter wherein the instructions, when executed with the at least one processor, cause the apparatus to associate the at least one anchor parameter with the at least one audio scene anchor parameter to control a mapping of at least one audio element anchor to at least one anchor within the audio scene within which the at least one audio signal is to be rendered based on a time difference between the one audio element anchor and the at least one anchor within the audio scene; or
a priority list parameter wherein the instructions, when executed with the at least one processor, cause the apparatus to associate the at least one anchor parameter with the at least one audio scene anchor parameter to control a mapping of at least one audio element anchor to at least one anchor within the audio scene within which the at least one audio signal is to be rendered based on a priority list of candidate mappings.

14. The apparatus as claimed in claim 13, wherein the instructions, when executed with the at least one processor, cause the spatial filtering to control the mapping one of:
a nearest anchor selection for selecting at least one anchor within the audio scene nearest the at least one audio element anchor;
a farthest anchor selection for selecting at least one anchor within the audio scene farthest from the at least one audio element anchor;
a maximal spread anchor selection for selecting at least one anchor within the audio scene to distribute the at least one audio element anchor such that they are located with a largest spread; and
a user input based anchor selection.

15. The apparatus as claimed in claim 14, wherein mapping of the at least one audio element anchor to the at least one anchor within the audio scene is based on the time difference between the at least one audio element anchor and the at least one anchor within the audio scene to control the mapping based on one of:
an earliest anchor selection for selecting an earliest of the at least one anchor within the audio scene;
an earliest anchor selection for selecting an earliest of the at least one anchor within the audio scene with later modifications based on a user movement;
a maximal spread anchor selection for selecting the at least one anchor within the audio scene to distribute the one audio element anchors farthest from others; or
a user input based anchor selection.

16. The apparatus as claimed in claim 10, wherein the information configured to assist in the adaptation is a processor filtering parameter wherein the instructions, when executed with the at least one processor, cause the apparatus to associate the at least one anchor parameter with the at least one audio scene anchor parameter to control a mapping of at least one audio element anchor to at least one anchor within the audio scene based on a renderer processor value.

17. The apparatus as claimed in claim 10, wherein the information configured to assist in the adaptation is at least one of:
an alternative anchor filtering parameter wherein the instructions, when executed with the at least one processor, cause the apparatus to associate the at least one anchor parameter with the at least one audio scene anchor parameter to control a mapping of the at least one audio element anchor to an alternative one of at least one anchor within the audio scene where there is no matching label between the at least one audio element anchor and the at least one anchor within the audio scene;
a default position parameter wherein the instructions, when executed with the at least one processor, cause the apparatus to associate the at least one anchor parameter with the at least one audio scene anchor parameter to control a positioning of the at least one audio element anchor within the audio scene where there is no matching label between the at least one audio element anchor and the at least one anchor within the audio scene; or
a multiple anchors parameter comprising identifiers identifying at least two candidate anchors within the audio scene and wherein the instructions, when executed with the at least one processor, cause the apparatus to associate the at least one anchor parameter with the at least one audio scene anchor parameter to control a mapping to at least one of the candidate anchors within the audio scene based on at least one of the candidate anchors being located within the audio scene.

18. The apparatus as claimed in claim 10, wherein the instructions, when executed with the at least one processor, cause the apparatus to associate the at least one anchor parameter with the at least one audio scene anchor parameter to obtain an instance processing parameter configured to control a processing of instances of a mapping of the at least one audio element anchor to at least one of the at least one anchor within the audio scene.

19. The apparatus as claimed in claim 10, wherein the information is at least one of:
a mapping modification processing parameter wherein the instructions, when executed with the at least one processor, cause the apparatus to associate the at least one anchor parameter with the at least one audio scene anchor parameter to control a mapping modification or processing of instances of a mapping of the at least one audio element anchor to at least one of the at least one anchor within the audio scene; or
a dynamic updating parameter configured to control whether the at least one audio element anchor dynamically moves within the audio scene.

20-23. (canceled)

24. A method, comprising:
obtaining at least one audio signal;
obtaining at least one anchor parameter associated with the at least one audio signal; and
obtaining information configured to assist in an adaptation of the at least one anchor parameter with at least one further anchor parameter within an audio scene within which the at least one audio signal is to be rendered.

25. (canceled)

26. A method for rendering at least one audio signal within an audio scene, the method comprising:
determining, for the audio scene, at least one audio scene anchor parameter;
obtaining, from at least one further apparatus, a bitstream, comprising: the at least one audio signal; at least one anchor parameter associated with the at least one audio signal; and information configured to assist in an adaptation of the at least one anchor parameter with the at least one audio scene anchor parameter;
associating the at least one anchor parameter with the at least one audio scene anchor parameter based on the information configured to assist in the adaptation of the at least one anchor parameter with the at least one audio scene anchor parameter; and
rendering the at least one audio signal based on the association between the at least one anchor parameter with the at least one audio scene anchor parameter.
